(19) United States
(12) Patent Application Publication
(10) Pub. No.: US 2021/0082039 A1
(43) Pub. Date: Mar. 18, 2021

(54) METHOD AND SYSTEM FOR PREDICTING ADVERSE BALANCE DIMINISHMENT

(71) Applicant: Wells Fargo Bank, N.A., San Francisco, CA (US)

(72) Inventors: Cigdem Gencer, San Francisco, CA (US); Dana K. Zuber, Oakland, CA (US); Michelle L. Bellanger, San Francisco, CA (US); Evelyn Ujanen, San Francisco, CA (US); Eric R. Legrand, Albany, CA (US); Matthew P. Schlachtman, San Francisco, CA (US)

(21) Appl. No.: 14/813,649

(22) Filed: Jul. 30, 2015

(51) Int. Cl. G06Q 40/02

(52) U.S. Cl. CPC G06Q 40/02

(57) ABSTRACT

Systems and methods for identifying and reducing the risk of adverse balance diminishment through the analysis of characteristics of customers associated with past incidences of adverse balance diminishment are described. By processing information relating to the behavior and characteristics of customers whose balances at a financial institution have previously exhibited adverse balance diminishment, a meaningful predictive model of adverse balance diminishment can be constructed. The predictive model can then be used to identify opportunities for a financial institution to take preventative measures to reduce the risk of adverse balance diminishment among its customers.

### BACKGROUND

Customer account balances at a financial institution may vary widely over the course of time. For example, a customer may purchase a large item (e.g., a new home or vehicle), which may cause a long term reduction in the customer's account balances. As another example, some customers may have irregular pay schedules (e.g., a teacher that does not get paid during the summer, a seasonal worker that does not get paid in the winter, a salesperson that receives significant one-time commissions when sales close, and so on), which may result in higher account balances at some points in time and lower account balances at other points in time.

### SUMMARY

One embodiment of the invention relates to a financial institution computing system. The system includes a database, an analysis logic, a diminishment logic, a segmentation logic, and a post-processing logic. The database includes information relating to a plurality of customers of a financial institution, including customer assets at the financial institution. The analysis logic is configured to compile a set of customer data from the database. The diminishment logic is configured to identify incidences of adverse balance diminishment in the set of customer data. The segmentation logic is configured to organize customer characteristics associated with incidences of adverse balance diminishment into clusters. The post-processing logic is configured to compare existing customer information to the clusters. The post-processing logic is further configured to compile existing customers at risk of adverse balance diminishment.

Another embodiment of the invention relates to a computer-implemented method. The method includes maintaining, by an analysis logic, a database comprising information relating to a plurality of customers of a financial institution, including customer assets at the financial institution. The method further includes compiling, by an analysis logic, a set of customer data from the database. The method includes identifying, by a diminishment logic, incidences of adverse balance diminishment in the set of customer data. The method further includes organizing, by a segmentation logic, customer characteristics associated with incidences of adverse balance diminishment into clusters. The method includes comparing, by a post-processing logic, existing customer information to the clusters. The method further includes identifying, by a post-processing logic, existing customers at risk of adverse balance diminishment.

Yet another embodiment of the invention relates to a non-transitory computer readable media having computer-executable instructions embodied therein that, when executed by a processor of a financial institution computing system, cause the financial institution computing system to perform operations to identify and reduce the risk of adverse balance diminishment. The operations include maintaining a database comprising information relating to a plurality of customers of a financial institution, including customer assets at the financial institution. The operations further include compiling a set of customer data from the database. The operations include identifying incidences of adverse balance diminishment in the compiled set of customer data. The operations further include organizing customer characteristics associated with incidences of adverse balance diminishment into clusters. The operations include comparing existing customer information associated to the clusters. The operations further include identifying existing customers at risk of adverse balance diminishment.

### BRIEF DESCRIPTION OF THE FIGURES

FIG. 1 is a schematic diagram of a computer-implemented system for identifying and reducing the risk of adverse balance diminishment according to an example embodiment.

FIG. 2 is an illustrative diagram of various representative patterns of adverse balance diminishment, according to an example embodiment.

FIG. 3 is an illustrative diagram of an image presented on a display by a user interface, according to an example embodiment.

FIG. 4 is a flow diagram of a method of identifying and reducing the risk of adverse balance diminishment, according to an example embodiment.

### DETAILED DESCRIPTION

Referring to the figures generally, according to example embodiments, systems and methods for identifying customers of a financial institution who are at risk of adverse balance diminishment are described. The systems and methods disclosed herein provide a predictive model that allows financial institutions to identify and address risk factors that indicate an appreciable likelihood of future adverse balance diminishment. By analyzing historical financial data relating to a financial institution's customers, identifying customers whose balances have significantly diminished under adverse circumstances, and running a series of statistical processes on those customers' data, a financial institution can identify consistent personal, demographic, and behavioral information that indicate a significant risk of adverse balance diminishment in particular customers. The financial institution can then use these risk factors to address potential causes of adverse balance diminishment before they occur. In turn, the systems and methods disclosed herein may similarly provide a predictive model of future increased account utilization by identifying corresponding consistent personal, demographic, and behavioral indicators of growth (e.g., by analyzing historical financial data, but in the context of individuals with increasing account utilization).

Balance diminishment is a significant decrease in customer account balances, and can occur for any of several reasons and may even be considered normal or cyclical for some customers. However, adverse balance diminishment occurs when a customer ultimately reduces or drops altogether their account balances and transaction activities at a financial institution, which can be due to dissatisfaction. For example, a database of customer account information is analyzed to identify customers that exhibit balance diminishment. In some embodiments, the customers are further filtered based on other parameters, such as exhibiting certain patterns of account behavior. For example, customers with account balances that change frequently and significantly during the period under study may be excluded. Such customers may exhibit patterns of balance diminishment, however, such patterns may be the result of the way the customer normally transacts, rather than a result of the customer being in any way dissatisfied with the services of the financial institution. As another example, customers with balances that remained very low during the period under study may be excluded. In some embodiments, customers are grouped according to household units. For example, two or more (potentially unrelated) customers living at the same address may be treated as a single customer for purposes of data analysis. For example, a 30-yr old male and a 30-yr female who live at the same address may be treated as a single customer. If the 30-yr female then transfers a significant amount of money to the male, this would not be identified as an instance of balance diminishment, since the overall account balance of the two customers remains unchanged. Upon filtering those customers whose balance diminishment behavior appears to be unrelated to customer satisfaction, the remaining customers may be considered as at risk of or already exhibiting adverse balance diminishment.

In some embodiments, the period under study may extend to a present time. Such an arrangement may be used to identify customers that are currently at risk of adverse balance diminishment. For example, an analysis may be performed to identify customers having accounts that have experienced balance diminishment over a period of time, and currently in a state of having a diminished account balance as compared to an earlier point in time. The customers identified as having diminished account balances may then be filtered as noted above and proactive measures may then be taken to reduce the risk of adverse balance diminishment for the remaining customers. For example, a workflow task may be assigned to a customer service representative to reach out to the customer to identify and address any customer service issues. As another example, the customer may be contacted through a communication channel (e.g., text messages, emails, US postal mail, etc.) and provided with offers that address perceived customer service issues.

In some embodiments, customers that have exhibited adverse balance diminishment in the past are identified. Transaction data for all customers may then be analyzed and a cluster analysis may be performed. The cluster analysis may group customers based common transaction patterns into customer segments. For example, particular clusters may have a high percentage of customers that have exhibited adverse balance diminishment. The transaction pattern associated with that cluster would then be predictive of adverse balance diminishment. A search may then be made for current customers that exhibit those transaction patterns, as such customers may be considered at high risk for adverse balance diminishment.

For example, transaction data analysis may reveal that a high percentage of customers who have recently exhibited adverse balance diminishment only had a single checking account and recently received an overdraft fee. As such, existing single-account customers who have received an overdraft notice and fee can be identified and preventative measures can be taken to reduce the risk of subsequent adverse balance diminishment. An example measure can include contacting those customers and offering overdraft protection services. Those overdraft protection services may involve opening up a line of credit or assigning a credit card to the customer's checking account to provide backup funds in the event of a future overdraft. Further, if a financial institution representative still believes that the customer would still be at risk of adverse balance diminishment, the representative can waive the previously issued overdraft fee.

As previously noted, an adverse balance diminishment indicates that the customer may in some way be unhappy with one or more aspects of the services of the financial institution. Hence, the adverse balance diminishment itself is desirable to avoid. Therefore, in further embodiments, the clustering analysis described above is performed to identify customers that are at risk of adverse balance diminishment, allowing proactive measures to be taken to avoid the adverse balance diminishment. For example, customers who exhibit transaction patterns that are highly correlated with adverse balance diminishment may be considered at risk of adverse balance diminishment.

The arrangements described herein provide for a more accurate identification of customers with accounts that are likely to experience adverse balance diminishment. The arrangements described herein also provide for more rapid deployment of counteractive measures to prevent such adverse balance diminishment from occurring.

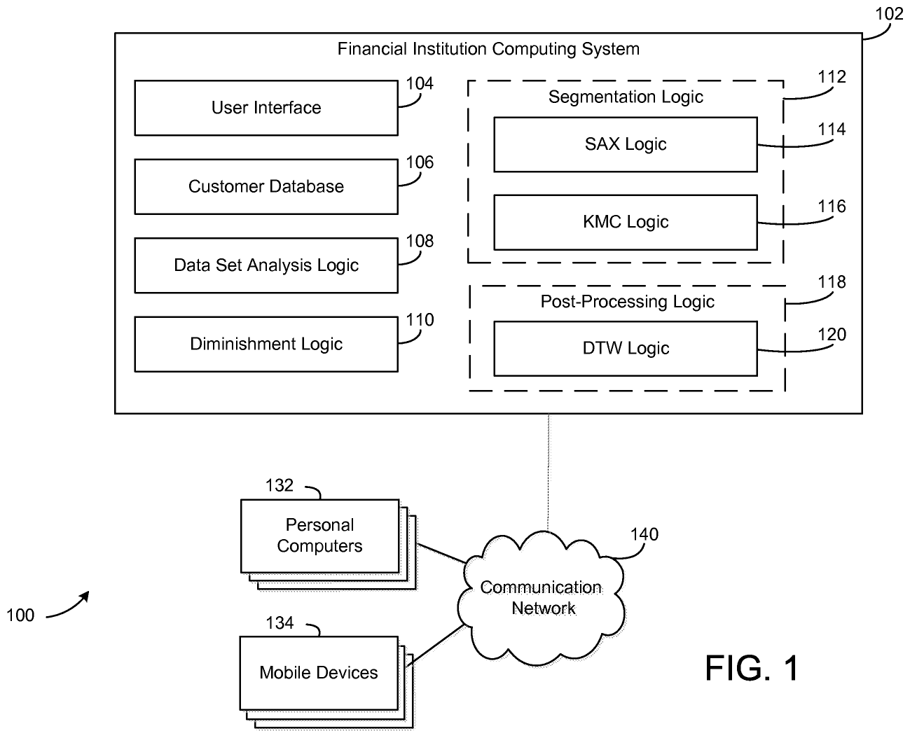

Referring to FIG. 1, a schematic diagram of a computer-implemented predictive modeling system 100 is shown according to an example embodiment. By applying operations on sets of financial institution customer data via a financial institution computing system 102, system 100 can identify customers at risk of future adverse balance diminishment. Customers may include business entities and/or individuals having one or more accounts with the financial institution. Financial institutions are banking entities capable of maintaining various types of customer accounts and offering various financial products and services. Financial institutions may include, for example, commercial or private banks, credit unions, or investment brokerages.

Still referring to FIG. 1, the system 100 includes the financial institution computing system 102. Financial institution computing system 102 processes a set of customer data, identifying customers at risk of future adverse balance diminishment. Proactive measures may then be taken to reduce the risk of adverse balance diminishment. Financial institution computing system 102 includes a user interface 104, a customer database 106, an analysis logic 108, a diminishment logic 110, a segmentation logic 112, and a post-processing logic 118. The relationships between these various aspects of financial institution computing system 102 are described in further detail below.

User interface 104 allows a user associated with the financial institution to interact with and adjust various parameters and operations performed by financial institution computing system 102. In some arrangements, user interface 104 is a graphical user interface, complete with text, menus, images, and interactive controls that appear on a screen or monitor associated with financial institution computing system 102. In other arrangements, user interface 104 is an interactive menu displaying various adjustable parameters that can be applied by financial institution computing system 102. User interface 104 can be configured to allow a user to set a period of time that will be used to generate a predictive model for adverse balance diminishment (e.g., the past two years, beginning with today's date). User interface 104 may also provide a user interface to a workflow system for customer service representatives of the financial institution. The workflow system may provide tasks for customer services to reach out to at risk customers. Such customers may also be contacted electronically, e.g., may be presented with electronic offers via text message or email via devices 132, 134 connected to the institution financial computing system 102 via a network 140 (e.g., internet, cellular telephone network, and so on).

Customer database 106 contains information relating to a plurality of customers at the financial institution. The information associated with each customer in customer database 106 can include, for example, the number of accounts at the financial institution, the types of accounts at the financial institution, account histories, transaction histories, debt histories, asset value information, customer service logs, and the like. Customer database 106 can be stored at financial institution computing system 102 on any of several digital storage mediums such as cloud-based servers, disc-based or flash-based hard drives, local servers, or a combination thereof. Although customer database 106 is represented as a single unit in FIG. 1, customer database 106 can be divided and stored in several storage mediums of varying types and in different, even remote, locations.

Data set analysis logic 108 is configured to prepare a set of data from customer database 106. In some arrangements, analysis logic 108 is configured to pull information relating to deposit, investment, and retirement assets (“DIR assets”) for each of the financial institution's customers from customer database 106. While other types of data can be used for the predictive modeling process (e.g., data relating to customer real estate assets, mortgages, credit card carryover, precious metals, artwork, jewelry, and so on), “DIR assets” will be used as an example set of data in the discussions below. In some of these arrangements, analysis logic 108 can be further configured to arrange the information pulled into units of “household” financial data, wherein DIR assets of multiple customers living in the same household are combined for the purposes of generating a predictive model as discussed below, even though the customers are not joint account holders. For example, the units of household financial data may comprise data for two people who are not joint account holders but who are living at the same address, even if there is no other legal/marital family relationship between the two people.

Analysis logic 108 can be configured to perform a series of operations to filter out customers whose financial information is not likely to be useful in generating a predictive model of adverse balance diminishment. For example, analysis logic 108 can be configured to identify and filter customers (and/or households, depending on the arrangement) with extreme increases or drops in their DIR assets during a relevant time period (i.e., the time period subject to predictive modeling, as set by a user interacting with user interface 104). Analysis logic 108 can also be configured to filter customers with DIR assets that fluctuated significantly over the relevant time period. For example, a parameter can be set (e.g., via user interface 104) where analysis logic 108 filters out customers whose DIR assets deviated at least three times by at least one standard deviation during the relevant time period. Analysis logic 108 can also be configured to filter customers whose DIR assets remained very low (e.g., less than $1,000.00) over the relevant time period. Analysis logic 108 can also be configured to transfer the set of customer data to diminishment logic 110 upon completion of its assigned operations.

Diminishment logic 110 is configured to identify incidences of balance diminishment from a customer data set. Diminishment logic 110 can be configured to apply a parameter (e.g., a default value such as a percentage or ratio, or a percentage or ratio set by a user via user interface 104) to determine whether a decrease in DIR assets over the relevant time period for a given customer was sufficient to be deemed an incidence of balance diminishment.

Diminishment logic 110 can be configured to filter out customers and their respective data if they did not present an incidence of balance diminishment over the relevant time period. Diminishment logic 110 also can be configured to transfer a resulting diminishment data set corresponding to customers meeting balance diminishment criteria to segmentation logic 112.

Segmentation logic 112 is configured to perform clustering analysis on the customers in the diminishment data set. For example, the segmentation logic 112 may be configured to place customers that have similar transaction patterns into clusters, and then determine which clusters of customers exhibit disproportionately high patterns of adverse balance diminishment. Transactions may include financial transactions, interactions with personnel (e.g., customer service representatives) of the financial institution, and so on. In one such an arrangement, segmentation logic 112 can be configured to review changes in DIR asset values for the customers in the diminishment data set and identify representative balance diminishment patterns over the course of the relevant time period. In another arrangement, segmentation logic 112 is configured to generate balance diminishment pattern information for each of the customers in the diminishment data set. Segmentation logic 112 may be configured to search for and compile sets of common characteristics shared among all or a significant number of customers in the database. These characteristics can include, for example, income brackets, number of interactions with a financial institution's customer services, tenure with the financial institution, and other parameters used in the cluster analysis. In some of these arrangements, segmentation logic 112 is configured to populate a list of the top most common characteristics (e.g., a top ten characteristics list, as set by default or by a user via user interface 104). In others of these arrangements, segmentation logic 112 is configured to populate a list of characteristics and sort them by decreasing frequency across the customers in the diminishment data set. As such, segmentation logic 112 can identify the most common customer characteristics and behaviors that can indicate a likelihood of a forthcoming adverse balance diminishment.

In one such arrangement where segmentation logic 112 is configured to identify balance diminishment patterns, segmentation logic 112 can identify these patterns via a SAX logic 114 and a KMC logic 116. SAX logic 114 is configured to identify a plurality of patterns of DIR asset value changes from the diminishment data set. SAX logic 114 can be configured to identify the patterns through the use of the process known as symbolic aggregate approximation (“SAX”). SAX is a data processing procedure wherein a set of time-series data is converted into a string of symbolic characters, each character designating an increment of some value (e.g., a customer's DIR asset value) at a given time interval. As such, SAX logic 114 can be configured to convert a customer's DIR asset values throughout a relevant time period (e.g., the past two years) into a string of characters (e.g., “abbeezza . . . ”). A string of characters produced by SAX logic 114 therefore corresponds to a given customer's pattern of DIR asset changes throughout the relevant time period. SAX logic 114 can be configured to transfer the resulting strings of characters for the customers (or households, depending on the arrangement) in the diminishment data set to KMC logic 116 as a pattern data set.

KMC logic 116 can be configured to organize a set of pattern data into representative balance diminishment patterns. In one arrangement, KMC logic 116 is configured to organize the patterns in the pattern data set into a set number of representative patterns (e.g., the number being set by default, or set by a user via user interface 104), for example, five representative patterns. In which case, KMC logic 116 can be configured to review the patterns in the pattern data set to generate five representative patterns of balance diminishment within the pattern data set. The KMC logic 116 can be further configured to cluster the patterns in the pattern data set to the most similar representative balance diminishment pattern out of various representative patterns. This can be done, for example, through the use of a process known as k-means clustering (“KMC”). KMC is a procedure for partitioning data into a defined number of clusters, wherein a given data point is partitioned to the cluster with the closest “mean” value to the data point. As such, the makeup of each data point in a given cluster influences the value (i.e., the mean) of that cluster. In the context of balance diminishment patterns, KMC can partition pattern data sets into clusters with a “mean” pattern for each cluster (e.g., a collective pattern shape, or an average of SAX-derived character strings), with the “mean” pattern being a pattern arising from the average shape of the balance diminishment patterns associated with a given cluster.

Post-processing logic 118 is configured to use the common characteristics generated by segmentation logic 112 to provide a user with a meaningful predictive model of adverse balance diminishment characteristics. In one arrangement, post-processing logic 118 is configured to generate information relating to the likelihood of a forthcoming incidence of adverse balance diminishment for a given customer. The likelihood of a forthcoming adverse balance diminishment can be determined, for example, by comparing a given customer's characteristics with common characteristics correlated with adverse balance diminishment, as generated by the segmentation logic 112. Upon comparing a given customer's characteristics with the set of common characteristics associated with adverse balance diminishment, a predictive assessment of a forthcoming adverse balance diminishment by that customer can be made (e.g., automatically by financial institution computing system 102). For example, if the customer fits in a cluster that is characterized by a high percentage of adverse balance diminishment, then the customer may be considered as having characteristics in common with characteristics that are highly correlated with adverse balance diminishment. As such, the predictive assessment may be that the customer is at risk for a forthcoming adverse balance diminishment (unless proactive measures are taken).

In an example embodiment, post-processing logic 118 is configured to determine whether a given customer's DIR asset behavior is similar to any representative patterns shown to indicate a likelihood of future adverse balance diminishment (e.g., a cluster pattern generated by segmentation logic 112). The DIR asset behavior may be the account balance and transaction history of the DIR assets. In such an arrangement, post-processing logic 118 can be configured to create a pattern of the customer's DIR asset behavior over a period of time, and attempt to match the pattern with a representative pattern indicating a likelihood of future adverse balance diminishment (e.g., a representative cluster pattern, as generated by segmentation logic 112).

In determining whether the customer fits within a particular cluster, the cluster analysis may utilize DTW logic 120. DTW logic 120 is configured to perform a process known as dynamic time warping (“DTW”), which applies an algorithm for measuring similarities among sets of time-based, sequential data. DTW can identify similarities among sets sequential data at different points in time within each respective data set. As such, here, DTW logic 120 can identify occurrences of a representative pattern within a given customer's DIR asset pattern. In some arrangements, the DTW logic 120 matches the DIR asset pattern length (e.g., behavior over the course of a year) to representative patterns of the same or similar lengths of time (e.g., pattern lengths of a year). In other arrangements, DTW logic 120 can match a customer's DIR asset patterns over a different length of time than the length of time used to generate the representative patterns (e.g., where a time period of two years was used to generate a set of representative patterns, DTW logic 120 can match a customer's DIR asset pattern taken from the past five years, or just the past year).

DTW logic 120 can be configured to allow only a specified level of tolerance (e.g., by a user via user interface 104) for deviations from the course of a representative pattern, such that a customer's pattern will not match with a representative pattern if it is not sufficiently similar to any of them. If DTW logic 120 does not match a customer's pattern with any of the representative patterns, post-processing logic 118 can determine that the customer is not significantly at risk of a forthcoming adverse balance diminishment. If DTW logic 120 does match a customer's pattern with a representative pattern, common characteristics of the customers making up that representative pattern can be used for analysis and to reduce the risk of adverse balance diminishment. In any event, results of the procedures performed by post-processing logic 118 can be presented to a user via user interface 104.

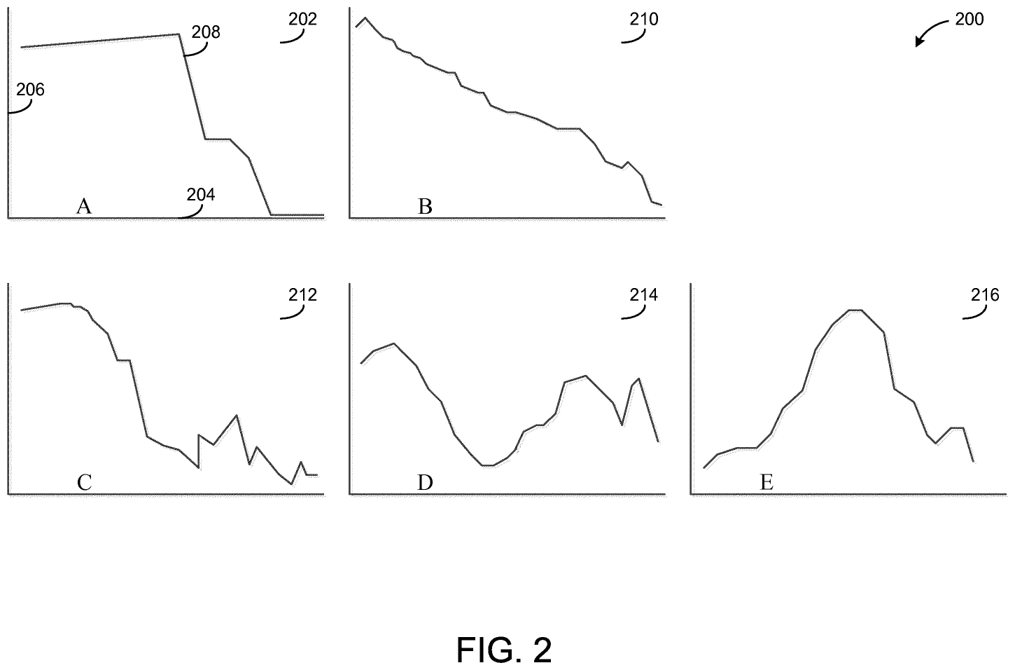

Referring now to FIG. 2, five illustrations 200 of representative patterns of customer DIR asset behavior (e.g., as generated by segmentation logic 112) giving rise to incidences of balance diminishment are shown according to an example embodiment. Each illustration is a representation of a time-based sequence of data, including an X-axis 204, a Y-axis 206, and a pattern line 208. X-axis 204 represents a period of time, here the period of time used to generate the representative patterns (e.g., the previous two years, as set by default or by a user via user interface 104). Y-axis 206 represents a range of DIR asset values. Pattern line 208 indicates a representative pattern's changes of DIR asset values (i.e., as indicated by the position of a point on pattern line 208 relative to Y-axis 206) over a period of time (i.e., as indicated by the position of a point on pattern line 208 relative to X-axis 204). Illustration A 202, illustration B 210, illustration C 212, illustration D 214, and illustration E 216 are depictions of five representative patterns of balance diminishment, some or all of which may be indicative of adverse balance diminishment, as identified from the diminishment set by segmentation logic 112. Each illustration can also be associated with and/or be organized by clusters of characteristics that are not directly related to DIR asset values, including household composition, demographic information, number and type of accounts, and the like.

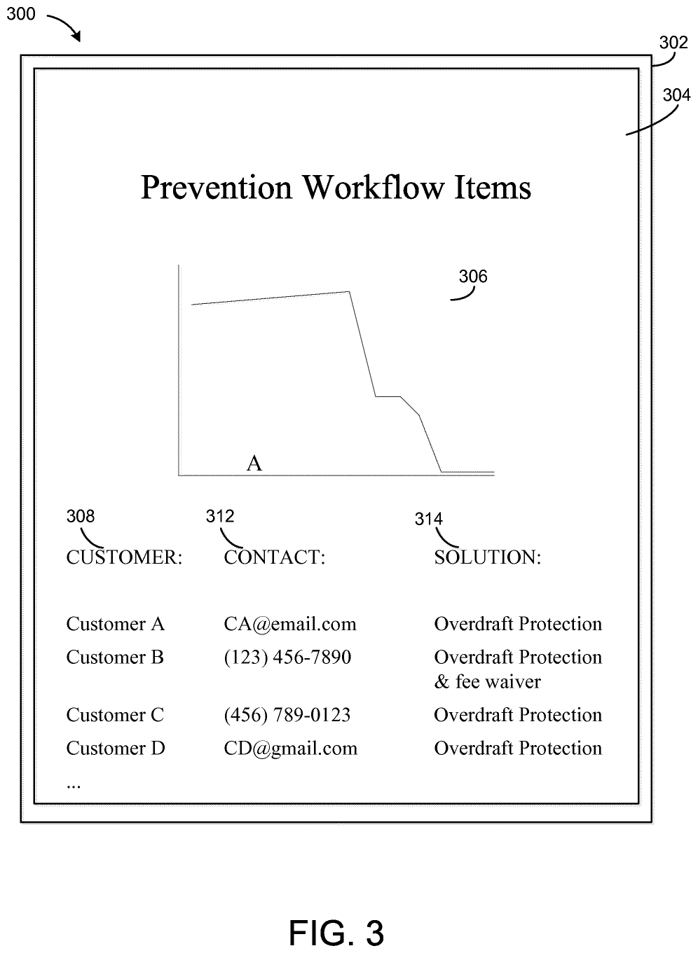

Referring now to FIG. 3, an illustrative diagram of user interface 104 is shown according to an example embodiment. User interface 104 is shown as an image 304 on a display 302. Display 302 is any of several types of imaging screens associated with a computing device, configured to present images, video, or text corresponding to a digital output from a computing device (e.g., financial institution computing system 102) to a user. Examples of display 302 include computer monitors, laptop computer screens, smartphone screens, tablet screens, television screens, and the like. Image 304 corresponds to information user interface 104 is configured to present to a user at a given time.

Here, user interface 104 is causing display 302 to present image 304 of adverse balance diminishment prevention workflow items, which contains an information profile corresponding to a representative balance diminishment pattern corresponding to illustration A 202. Image 304 includes a subject cluster pattern 306 (e.g., illustration A 202), a list of at-risk customers 308, a list of contact information 312, and a list of suggested solutions 314. Subject cluster pattern 306 is a visual representation of a cluster pattern of interest. The list of at-risk customers 308 is a list of current financial institution customers who fit patterns and characteristics associated with the cluster shown as illustration A 202. As such, the list of at-risk customers 308 includes identifying information for those customers who are similar to a particular cluster of customers exhibiting adverse balance diminishment, and are thus at risk of exhibiting adverse balance diminishment themselves. The list of contact information 312 includes preferred contact information for each individual appearing in the list of at-risk customer 308, and can include mailing addresses, phone numbers, e-mail addresses, and the like. The list of suggestion solutions 314 includes possible preventative measures that can be taken in view of the patterns and characteristics associated with the cluster at hand. For example, if the cluster shown as illustration A includes a close temporal relationship between one or more overdraft fees and adverse balance diminishment, a suggested solution can include offering overdraft protection and/or waiving overdraft fees before the customers in the list of at-risk customers 308 exhibit adverse balance diminishment.

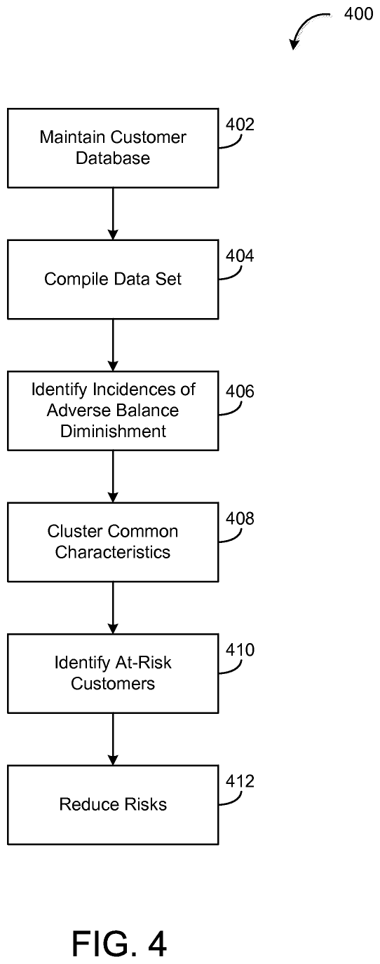

Referring to FIG. 4, a flow diagram of a method 400 of preventing adverse balance diminishment is shown according to an example embodiment. The method 400 is performed by a financial institution computing system (e.g., financial institution computing system 102), which has a customer database containing a plurality of information relating to the financial institution's customers (e.g., customer database 106). As discussed above with respect to system 100 and in further detail below with respect to method 400, the financial institution's computing system uses historical customer data to identify clusters of common characteristics associated with incidences of adverse balance diminishment, which can be used by a financial institution to identify and execute preventive measures before adverse balance diminishment takes place.

Method 400 begins when a customer database is maintained (402). The financial institution computing system maintains a customer database (e.g., customer database 106) containing personal and financial information for a plurality of customers of the financial institution. The information associated with each customer in the customer database can include, for example, the number of accounts at the financial institution, the types of accounts at the financial institution, account histories, transaction histories, debt histories, asset value information, customer service logs, and the like. The information in the customer database can be further maintained to be organized by households with multiple associated individuals. As such, method 400 can be performed, for example, on a customer level or a household level, depending on the arrangement.

A data set is compiled from the customer database (404). Customers in the customer database that are unlikely to provide meaningful data in determining common characteristics associated with adverse balance diminishment are ignored, while the data set is compiled from the remaining customers. For example, the data set can be compiled such that customers with extreme increases or drops in their DIR assets during a relevant time period (i.e., the time period subject to predictive balance diminishment modeling, as set by a user interacting with a user interface at the financial institution computing system) are excluded. The data set can also be compiled such that customers with DIR assets that fluctuated significantly over the relevant time period are excluded. The data set can be further compiled such that customers whose DIR assets remained very low (e.g., less than $1,000.00) over the relevant time period are excluded. In some arrangements, all of the remaining customers are included in the compiled data set. In other arrangements, a maximum number of customers are included in the compiled data set.

Incidences of adverse balance diminishment within the data set are identified (406). An incidence of adverse balance diminishment occurs if the value of a customer's assets at the financial institution at the beginning of the relevant time period is significantly less than the value of the customer's assets at the end of the relevant time period and the customer reduces or ceases transaction activity with the financial institution, which may be a result of customer dissatisfaction. In some arrangements, adverse balance diminishment is indicated by a balance diminishment of a specific threshold percentage drop in asset value. Further, in some arrangements, adverse balance diminishment is indicated by a balance diminishment plus a significant reduction in the frequency of financial transactions with the financial institution. Customers associated with incidences of adverse balance diminishment are retained, while the remaining customers are filtered out of the data set.

Common characteristics of adverse balance diminishment are clustered (408). Common characteristics of adverse balance diminishment are clustered by aggregating characteristics and behaviors associated with the incidences collected at 406. Characteristics can include, for example, income, asset value, tenure, patterns in deposits, withdrawals, and allocations of assets associated with a customer, number of interactions with the financial institution, number of non-financial institution ATM withdrawals, and the like. Characteristics can further include data relating to customer communications with the financial institution, including the frequency and subject matter of communications via phone, live online chat services, in store, e-mail, and so on, along with the reasons for those communications.

In one arrangement, common characteristics are clustered by generating a plurality of asset value patterns associated with the customers showing adverse balance diminishment over the relevant time period. Asset value patterns can be generated, for example, via a SAX process, and then clustered into representative patterns via a KMC process (e.g., via SAX logic 114 and KMC logic 116). In another arrangement, common characteristics are clustered by collecting individual types of characteristics (e.g., number of interactions with the financial institution, number of non-financial institution ATM withdrawals, and so on) that are consistent among the customers showing adverse balance diminishment over the relevant time period. In yet other arrangements, both individual characteristics and asset value patterns are incorporated into customer clusters. In some of these arrangements, a maximum level of data variance is applied such that each cluster of behaviors or characteristics meet some minimum level of similarity.

At-risk customers are identified (410). At-risk customers are identified by comparing a given customer's characteristics with the clusters of characteristics associated with adverse balance diminishment from 408. If a given customer exhibits patterns, behaviors, attributes, or some combination of these characteristics that is similar to one or more of the clusters, that customer may be considered as at-risk of adverse balance diminishment. In some arrangements, a minimum magnitude of similarity can be required, such that a given customer may be considered at risk of adverse balance diminishment if a minimum number of criteria from a given cluster are met (e.g., three criteria such as no mortgage, more than five non-financial institution ATM withdrawals in the past three months, and a tenure of less than two years with the financial institution). In some arrangements, an at-risk customer is a customer who has already exhibited a balance diminishment, but is at risk of a subsequent adverse balance diminishment.

In one arrangement, an at-risk customer is identified by comparing their asset value pattern over a period of time with a set of representative adverse balance diminishment clusters (e.g., as clustered at 408, for example, by segmentation logic 112). The comparison may be made by performing a DTW procedure to attempt to match a customer's asset value pattern to one of the representative patterns. In some arrangements, a maximum level of variance is set, such that the customer's asset value pattern will not match if it is sufficiently distinct from any of the representative clusters. As such, an at-risk customer may be identified if the customer's asset value pattern matches one of the representative clusters.

A risk of adverse balance diminishment is reduced (412). The risk of adverse balance diminishment for a given customer may be reduced by identifying common issues among other customers in the corresponding cluster(s), and taking an appropriate remedial or preventative course of action. For example, solutions for common issues associated with each cluster created at 408 can be created and stored. As such, if a given customer's characteristics matches cluster pattern A, a financial institution computing system can retrieve and recommend corresponding solutions for customers fitting cluster pattern A. For example, if a high number of customer interactions with customer service and the absence of a mortgage are significant characteristics of cluster pattern A, recommended solutions may include reviewing any relevant customer service logs and reaching out to the customer with personalized services, or offering a mortgage with generous terms. A financial institution may otherwise attempt to reduce the risk of adverse balance diminishment in a less tailored fashion, for example, by proactively providing the customer with universally appreciable products or services (e.g., fee waivers, credit card point multipliers, or the like).

As noted above, embodiments within the scope of this disclosure include program products comprising non-transitory machine-readable media for carrying or having machine-executable instructions or data structures stored thereon. Such machine-readable media can be any available media that can be accessed by a general purpose or special purpose computer or other machine with a processor. By way of example, such machine-readable or non-transitory storage media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of executable instructions or associated data structures represents examples of corresponding acts for implementing the functions described in such steps.

As previously indicated, embodiments may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the embodiments might include a general purpose computing computers in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A financial institution computing system for detecting customers at risk of adverse balance diminishment, the system associated with a first financial institution and communicatively coupled to a communications network and comprising at least one processor, the system further comprising:
a database associated with at least one computer-readable storage media communicatively coupled to the at least one processor, the database comprising information relating to a plurality of customers of the first financial institution, including customer assets at the first financial institution;
an analysis logic associated with the at least one computer-readable storage media communicatively coupled to the at least one processor, the analysis logic configured to compile a set of customer data from the database;
a diminishment logic associated with the at least one computer-readable storage media communicatively coupled to the at least one processor, the diminishment logic configured to generate a diminishment data set comprising incidences of adverse balance diminishment in the set of customer data, wherein determining each incidence of adverse balance diminishment is based on a number of non-financial institution automated teller machine (ATM) transactions for a particular time period, and wherein each non-financial institution ATM transaction is remote to the first financial institution and takes place at an ATM operated by a second financial institution different from the first financial institution;
a segmentation logic associated with the at least one computer-readable storage media communicatively coupled to the at least one processor, the segmentation logic configured to organize customer characteristics associated with the incidences of adverse balance diminishment in the diminishment data set into clusters; and
a post-processing logic associated with the at least one computer-readable storage media communicatively coupled to the at least one processor, the post-processing logic configured to:
for each existing customer determined to be at risk of adverse balance diminishment,
determine that a financial product is relevant to the existing customer based on at least one customer characteristic determined by the segmentation logic;
generate a text message comprising an electronic financial product offer related to the financial product; and
transmit the text message, via the communications network, to a computing device associated with the customer at risk of adverse balance diminishment.

2. The system of claim 1, wherein the segmentation logic organizes the clusters by generating patterns.

3. The system of claim 2, wherein the patterns are generated through symbolic aggregate approximation.

4. The system of claim 2, wherein the segmentation logic is further configured to organize the patterns into representative patterns through k-means clustering.

5. The system of claim 1, wherein the post-processing logic is configured to compare customer information to the clusters through dynamic time warping.

6. (canceled)

7. A computer implemented method of detecting customers of a first financial institution who are at risk of adverse balance diminishment, the method comprising:
maintaining, by an analysis logic, a database comprising information relating to a plurality of customers of the first financial institution, including customer assets at the first financial institution;
compiling, by an analysis logic, a set of customer data from the database;
generating, by a diminishment logic, a diminishment data set comprising incidences of adverse balance diminishment in the set of customer data, wherein determining each incidence of adverse balance diminishment is based on a number of non-financial institution ATM transactions for a particular time period, and wherein each non-financial institution ATM transaction is remote to the first financial institution and takes place at an ATM operated by a second financial institution different from the first financial institution;
organizing, by a segmentation logic, customer characteristics associated with incidences of adverse balance diminishment in the diminishment data set into clusters;
for each existing customer determined to be at risk of adverse balance diminishment, performing, by the post-processing logic, computer-based operations comprising:
determining that a financial product is relevant to the existing customer based on at least one customer characteristic determined by the segmentation logic;
generating a text message comprising an electronic financial product offer related to the financial product; and
transmitting the text message, via the communications network, to a computing device associated with the customer at risk of adverse balance diminishment.

8. The method of claim 7, wherein the clusters are organized by generating patterns.

9. The method of claim 8, wherein the patterns are generated through symbolic aggregate approximation.

10. The method of claim 8, wherein the patterns are organized into representative patterns through k-means clustering.

11. The method of claim 7, wherein customer information is compared to the clusters through dynamic time warping.

12. (canceled)

13. A non-transitory computer readable media having computer-executable instructions embodied therein that, when executed by a processor of a financial institution computing system associated with a first financial institution, cause the financial institution computing system to perform operations to detect customers at risk of adverse balance diminishment, the operations comprising:
maintain a database comprising information relating to a plurality of customers of the first financial institution, including customer assets at the first financial institution;
compile a set of customer data from the database;
generate a diminishment data set comprising incidences of adverse balance diminishment in the compiled set of customer data, wherein determining each incidence of adverse balance diminishment is based on a number of non-financial institution ATM transactions for a particular time period, and wherein each non-financial institution ATM transaction is remote to the first financial institution and takes place at an ATM operated by a second financial institution different from the first financial institution;
organize customer characteristics associated with incidences of adverse balance diminishment in the diminishment data set into clusters;
for each existing customer determined to be at risk of adverse balance diminishment,
determine that a financial product is relevant to the existing customer based on at least one customer characteristic determined by the segmentation logic;
generate a text message comprising an electronic financial product offer related to the financial product; and
transmit the text message, via the communications network, to a computing device associated with the customer at risk of adverse balance diminishment.

14. The media of claim 13, wherein the clusters are organized by generating patterns.

15. The media of claim 14, wherein the patterns are generated through symbolic aggregate approximation.

16. The media of claim 14, wherein the patterns are organized into representative patterns through k-means clustering.

17. The media of claim 13, wherein customer information is compared to the clusters through dynamic time warping.

18. (canceled)

19. The system of claim 1, wherein each instance of adverse balance diminishment is identified based on a determination that a frequency of transactions for a customer in the set of customer data has decreased over a time period and based on a comparison, for the time period, of a decrease in value of the assets of the customer to a threshold percentage drop in asset value.

20. The system of claim 1, wherein, in response to the determined risk of adverse balance diminishment being based on a temporal relationship between at least one overdraft fee and adverse balance diminishment, the electronic financial product offer is a waiver of the at least one overdraft fee.
